(19) United States
(12) Patent Application Publication
(10) Pub. No.: US 2014/0343912 A1
(43) Pub. Date: Nov. 20, 2014

(54) PROVIDING CUSTOMIZED FUEL ECONOMY RATINGS BASED ON CUSTOMER DRIVE CYCLE

(71) Applicant: GM GLOBAL TECHNOLOGY OPERATIONS LLC, Detroit, MI (US)

(72) Inventor: Trevor J. Davis, Milford, MI (US)

(73) Assignee: GM GLOBAL TECHNOLOGY OPERATIONS LLC, Detroit, MI (US)

(21) Appl. No.: 13/898,100

(22) Filed: May 20, 2013

(51) Int. Cl. G06F 17/50

(52) U.S. Cl. CPC G06F 17/5009
USPC 703/8

(57) ABSTRACT

Disclosed herein are systems and methods for providing customized fuel economy ratings. The method includes collecting customer drive cycle information from a first vehicle operated by a customer and simulating an operation of a second vehicle based on the customer drive cycle information. Based on the simulating, the method includes calculating the customized fuel economy rating of the second vehicle.

### FIELD OF THE INVENTION

The subject invention relates generally to fuel economy ratings for vehicles, and more specifically to systems and methods for recording and analyzing customer drive cycle information to provide customized fuel economy ratings.

### BACKGROUND

Standard fuel economy ratings are provided for new vehicles to enable users to compare the fuel economy of multiple vehicles when shopping for a new vehicle. Currently, the standard fuel economy ratings are based off of a complex average of several drive cycles that attempt to provide customers with the most realistic fuel economy rating. Fuel economy ratings for different types of vehicles, such as extended range electric vehicles (EREV), plug in hybrid electric vehicles (PHEV), and hybrid electrical vehicles (HEV) on the market may be confusing and difficult for users to easily compare to one another.

In many cases, the fuel economy observed by the customer does not match their expectations, based on the standard fuel economy ratings, because of the wide variance in the way that different drivers operate the vehicles in the real world. Every driver has a unique driving style and places unique demands on their vehicle. For example, different drivers drive different distances on a daily basis, have different driving habits, and operate their vehicles in different environments. Each of these variables and many more affect the real life fuel economy of a vehicle. Because every driver and every commute is different, customers are often disappointed by the fuel economy they actually achieve with their new vehicle.

### SUMMARY OF THE INVENTION

In one exemplary embodiment, a method for providing a customized fuel economy rating includes collecting a customer drive cycle information from a first vehicle operated by a customer and simulating an operation of a second vehicle based on the customer drive cycle information. Based on the simulating, the method includes calculating the customized fuel economy rating of the second vehicle.

In another exemplary embodiment, a method for providing customized fuel economy ratings includes collecting customer drive cycle information from a first vehicle operated by a customer and simulating an operation of a plurality of vehicles based on the customer drive cycle information. Based on the simulating, the method includes calculating a customized fuel economy rating for each of the plurality of vehicles. The method also includes presenting the customized fuel economy ratings for each of the plurality of vehicles to the customer.

In yet another exemplary embodiment, a system for providing customized fuel economy ratings includes a recording device configured to collect customer drive cycle information from a first vehicle operated by a customer and a computer system configured to preform a method. The method includes receiving the customer drive cycle information from the recording device and simulating an operation of a second vehicle based on the customer drive cycle information. Based on the simulating, the method includes calculating a customized fuel economy rating of the second vehicle.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 illustrates a block diagram of a computer system for use in practicing the teachings herein;

FIG. 2 is a flow diagram of a method for providing customized fuel economy ratings in accordance with an exemplary embodiment; and

FIG. 3 is a block diagram of a recording device used for providing a customized fuel economy rating in accordance with an exemplary embodiment.

### DESCRIPTION OF THE EMBODIMENTS

The following description is merely exemplary in nature and is not intended to limit the present disclosure, its application or uses.

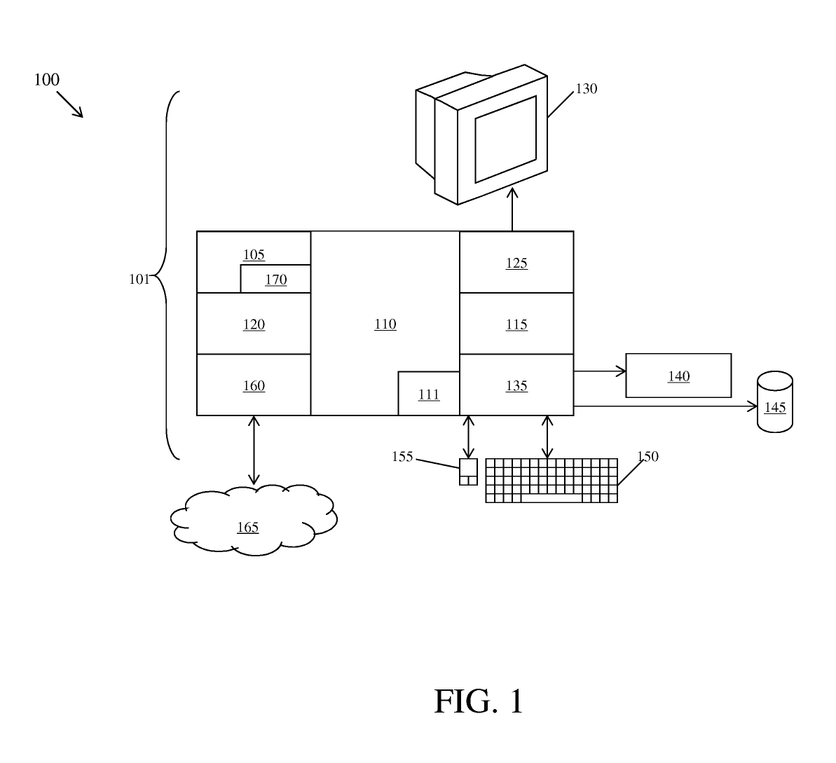

FIG. 1 illustrates a block diagram of a computer system 100 for use in practicing the teachings herein. The methods described herein can be implemented in hardware, software (e.g., firmware), or a combination thereof. In an exemplary embodiment, the methods described herein are implemented in hardware, and may be part of the microprocessor of a special or general-purpose digital computer, such as a personal computer, workstation, minicomputer, or mainframe computer. The computer system 100 therefore includes general-purpose computer 101.

In an exemplary embodiment, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing hardware instructions or software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a microprocessor, or generally any device for executing instructions. The processor 105 includes a cache 170 organized as a hierarchy of more cache levels (L1, L2, etc.).

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially controls the execution of other computer programs and provides scheduling, input-output control, file and data management, memory management, and communication control and related services.

In an exemplary embodiment, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In an exemplary embodiment, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In an exemplary embodiment, network 165 can be a managed IP network administered by a service provider. The network 165 may be implemented in a wireless fashion, e.g., using wireless protocols and technologies, such as Wi-Fi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the instructions in the memory 110 may further include a basic input output system (BIOS) (omitted for simplicity). The BIOS is a set of essential routines that initialize and test hardware at startup, start the OS 111, and support the transfer of data among the hardware devices. The BIOS is stored in ROM so that the BIOS can be executed when the computer 101 is activated. When the computer 101 is in operation, the processor 105 is configured to execute instructions stored within the memory 110, to communicate data to and from the memory 110, and to generally control operations of the computer 101 pursuant to the instructions.

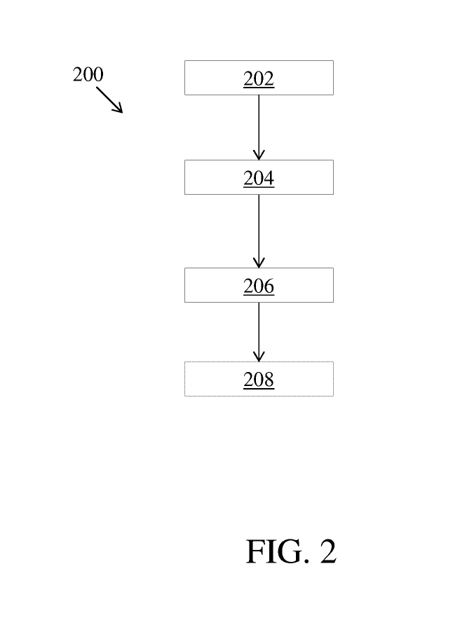

Referring now to FIG. 2, a flow diagram illustrating a method 200 for providing customized fuel economy ratings in accordance with an exemplary embodiment is shown. The method 200 begins at block 202 and includes collecting customer drive cycle information from a vehicle operated by a customer. In an exemplary embodiment, the customer drive cycle information may be collected by the use of a recording device that is configured to connect to the vehicle. For example, the recording device may be designed to plug into an OBD-II diagnostic connector of the vehicle. In other exemplary embodiments, the customer drive cycle information may be collected by the use of a recording device that can be built into the vehicle or simply disposed in the vehicle. Next, at block 204, the method 200 includes simulating an operation of a second vehicle based on the customer drive cycle information. Based on the simulation, the method 200 includes calculating a customized fuel economy rating of the second vehicle, as shown at block 206. In exemplary embodiments, the customer drive cycle information may be simulated in numerous vehicles and customized fuel economy ratings can be calculated for each of the numerous vehicles. At block 208, the method may also include presenting the customized fuel economy rating to the customer. In exemplary embodiments, presenting the customized fuel economy rating to the customer may include presenting a plurality of customized fuel economy ratings for a variety of vehicles.

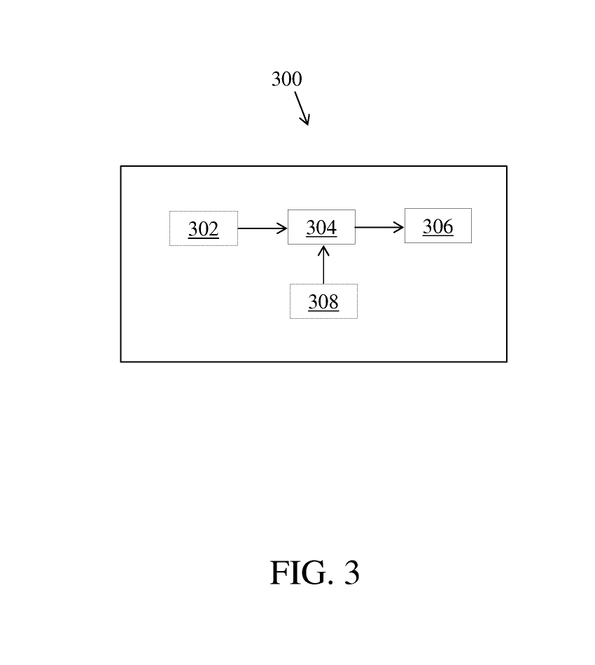

Referring now to FIG. 3, a block diagram of a recording device 300 in accordance with an exemplary embodiment is shown. The recording device 300 includes a storage device 304 and an interface 306. The recoding device 300 may also include a vehicle interface 302 and one or more sensors 308. In exemplary embodiments, the recording device 300 is configured to connect to a vehicle via the vehicle interface 302 and to receive a plurality of vehicle usage statistics during a period of time that the vehicle is being operated. For example, the vehicle interface 302 of the recording device 300 may be designed to plug into an OBD-II diagnostic connector of the vehicle.

The plurality of vehicle usage statistics that are collected during a period of time that the vehicle is being operated are collectively referred to herein as customer drive cycle information. The customer drive cycle information may include, but is not limited to, a distance driven by the customer during a period of time, a speed pattern over the distance, and environmental conditions that the first vehicle was operated in.

In exemplary embodiments, the recording device 300 may be configured to utilize the one or more sensors 308 to obtain vehicle usage statistics. In exemplary embodiments, the one or more sensors 308 may include, but are not limited to, one or more of the following: an accelerometer; a global positioning sensor; a gyroscope; or the like. In one example, the recording device 300 may be a smartphone, on another suitable device, that includes a GPS sensor, an accelerometer and a storage device. The smartphone may have an application that is configured to collect the vehicle usage statistics.

In exemplary embodiments, the recording device 300 is configured to store the collected vehicle usage statistics in the storage device 304, which may be a flash memory or any other suitable storage device. In exemplary embodiments, the interface 306 of the recording device 300 is configured to enable the recording device 300 to communicate with a computer system, such as the one shown in FIG. 1. In exemplary embodiments, the interface 306 may be a universal serial bus (USB) connector, a wireless transmitter, or the like. In exemplary embodiments, the recording device may be built into a vehicle and be configured to collect and transmit the vehicle usage statistics to a computer system for analysis. For example, the recording device may be configured to communicate with a computer system via a communications network, such as the OnStar® service. OnStar® is a registered trademark of OnStar, LLC.

In exemplary embodiments, a customer uses a recording device to record one or more drive cycles of interest, for example a commute to and from work. The drive cycle information is stored on the recording device and can be downloaded and analyzed by a computer system. The computer system is configured to run an algorithm, or perform a simulation, that will determine a customized estimated fuel economy rating for one or more vehicles based on the recorded drive cycle information. The customized estimated fuel economy ratings provide the customer with a more accurate estimated fuel economy than the standard fuel economy rating.

In exemplary embodiments, providing customers with customized fuel economy ratings for vehicles that they are considering buying allows customers to more accurately understand and compare the expected fuel economy of the vehicles. By recording the customer's personal drive cycle information, a dealership may be able to better pair each customer to the right choice of vehicle by calculating a more accurate estimation of what the customer's fuel economy could be for multiple vehicles based on their own personal drive cycle information. With the growing complexity of the many different types of vehicles on the market this process would help the customer understand which vehicles are better suited to their own personal driving needs. In exemplary embodiments, the method may include identifying and listing a price per day estimate of fuel expense for plug-in hybrid vehicles, battery electric vehicles, or fuel efficient conventional vehicles.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The flow diagrams depicted herein are just one example. There may be many variations to this diagram or the steps (or operations) described therein without departing from the spirit of the disclosure. For instance, the steps may be performed in a differing order or steps may be added, deleted or modified. All of these variations are considered a part of the claimed disclosure.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method for providing a customized fuel economy rating comprises:
collecting a customer drive cycle information from a first vehicle operated by a customer;
simulating an operation of a second vehicle based on the customer drive cycle information; and
based on the simulating, calculating the customized fuel economy rating of the second vehicle.

2. The method of claim 1, wherein collecting the customer drive cycle information from the first vehicle comprises connecting a recording device to an on-board vehicle diagnostics port of the first vehicle and recording a plurality of vehicle usage statistics over a period of time.

3. The method of claim 1, wherein collecting the customer drive cycle information from the first vehicle comprises recording a plurality of vehicle usage statistics during a period of time.

4. The method of claim 1, wherein the customer drive cycle information comprises a distance driven by the customer during a period of time, a speed pattern over the distance, and environmental conditions that the first vehicle was operated in.

5. The method of claim 1, further comprising presenting the customized fuel economy rating of the second vehicle to the customer.

6. A method for providing customized fuel economy ratings comprises:
collecting a customer drive cycle information from a first vehicle operated by a customer;
simulating an operation of a plurality of vehicles based on the customer drive cycle information;
based on the simulating, calculating a customized fuel economy rating for each of the plurality of vehicles; and
presenting the customized fuel economy ratings for each of the plurality of vehicles to the customer.

7. The method of claim 6, wherein collecting the customer drive cycle information from the first vehicle comprises connecting a recording device to an on-board vehicle diagnostics port of the first vehicle and recording a plurality of vehicle usage statistics over a period of time.

8. The method of claim 6, wherein collecting the customer drive cycle information from the first vehicle comprises recording a plurality of vehicle usage statistics during a period of time.

9. The method of claim 6, wherein the customer drive cycle information comprises a distance driven by the customer during a period of time, a speed pattern over the distance, and environmental conditions that the first vehicle was operated in.

10. A system for providing customized fuel economy ratings comprises:
a recording device configured to collect a customer drive cycle information from a first vehicle operated by a customer; and
a computer system configured to perform a method comprising:
receiving the customer drive cycle information from the recording device;
simulating an operation of a second vehicle based on the customer drive cycle information; and
based on the simulating, calculating a customized fuel economy rating of the second vehicle.

11. The system of claim 10, wherein the recording device comprises a vehicle interface, an interface and a storage device.

12. The system of claim 11, wherein the vehicle interface comprises an OBD-II diagnostic connector.

13. The system of claim 10, wherein the recording device comprises one or more sensors, an interface and a storage device.

14. The system of claim 10, wherein the customer drive cycle information comprises a plurality of vehicle usage statistics recorded during a period of time that the first vehicle was operated by the customer.

15. The system of claim 10, wherein the customer drive cycle information comprises a distance driven by the customer during a period of time, a speed pattern over the distance, and environmental conditions that the first vehicle was operated in.
